(19) United States
(12) Patent Application Publication
(10) Pub. No.: US 2013/0159104 A1
(43) Pub. Date: Jun. 20, 2013

(54) HIERARCHICAL FOLDERS FOR KEYWORD MANAGEMENT

(71) Applicant: Viswanathan Ramaiyer, Bangalore (IN)

(72) Inventor: Viswanathan Ramaiyer, Bangalore (IN)

(73) Assignee: MICROSOFT CORPORATION, Redmond, WA (US)

(21) Appl. No.: 13/329,227

(22) Filed: Dec. 17, 2011

(51) Int. Cl. G06Q 30/02

(52) U.S. Cl. 705/14.54; 705/14.71; 705/14.4

(57) ABSTRACT

A first indicator associated with a first group modification request to modify a first attribute value associated with each one of a plurality of keyword phrases that are stored as a first group indicating that the first group is included in a first hierarchical entity may be obtained. The first request may specify the first hierarchical entity as a target of the first group modification request. A first group modification of the first attribute value may be initiated, based on a first group modification of the first attribute value representing the first attribute value associated with each one of the plurality of keyword phrases, in response to the first group modification request.

### BACKGROUND

Users of electronic devices are increasingly relying on information obtained from the Internet as sources of news reports, ratings, descriptions of items, announcements, event information, and other various types of information that may be of interest to the users. Further, users are increasingly relying on advertisements that may appear on web pages such as search results to provide information that may be of interest with regard to their purchasing interests. Vendors may wish to arrange for advertisements of their services or products to appear as additional information to users who may be viewing or searching for particular types of items.

Advertising services may provide tools for vendors to create their own advertisements, and may offer subscriptions for advertising campaigns. For example, an advertising service may charge vendors a fee for user clicks on vendor advertisements (e.g., clicks by users to view further information introduced by the advertisement). For example, a user may enter keywords into a search engine, and vendor advertisements may appear on result pages. Vendors may generate large numbers of keywords or phrases related to their advertising campaigns, and may engage in many types of activities with regard to such keywords and phrases, in hopes that the users of electronic devices will view advertisements associated with the vendors.

### SUMMARY

According to one general aspect, a system may include a keyword phrase acquisition component that obtains a first plurality of keyword phrases associated with searches that are associated with a first topic. The system may also include a label acquisition component that obtains a first label corresponding to the first topic. The system may also include a keyword storage component that initiates storage of the first plurality of keyword phrases in association with a first hierarchical entity representing the first topic. The system may also include a hierarchical storage component that initiates, via a device processor, a first storage arrangement of the first hierarchical entity and a second hierarchical entity hierarchically related to the first hierarchical entity, the arrangement indicating a hierarchical relationship of the second hierarchical entity that is higher than the first hierarchical entity in a hierarchical storage arrangement. The system may also include a task request receiving component that obtains a first request to perform a first operation associated with each of the first plurality of keyword phrases, based on the first request indicating the first hierarchical entity as a target of the first request. The system may also include a task performance component that initiates a performance of the first operation associated with each of the first plurality of keyword phrases, in response to the first request indicating the first hierarchical entity as the target of the first request.

According to another aspect, storage of a first plurality of keyword phrases in association with a first hierarchical entity representing a first topic may be initiated. A first storage arrangement of the first hierarchical entity and a second hierarchical entity hierarchically related to the first hierarchical entity may be initiated, the arrangement indicating a hierarchical relationship of the second hierarchical entity that is higher than first hierarchical entity in a hierarchical storage arrangement. A first request to perform a first operation associated with each of the first plurality of keyword phrases may be obtained, based on the first request indicating the first hierarchical entity as a target of the first request. A performance of the first operation associated with each of the first plurality of keyword phrases may be initiated, in response to the first request indicating the first hierarchical entity as the target of the first request

According to another aspect, a computer program product tangibly embodied on a computer-readable storage medium may include executable code that may cause at least one data processing apparatus to obtain a first indicator associated with a first group modification request to modify a first attribute value associated with each one of a plurality of keyword phrases that are stored as a first group indicating that the first group is included in a first hierarchical entity, the first request specifying the first hierarchical entity as a target of the first group modification request. Further, the at least one data processing apparatus may initiate, via a device processor, a first group modification of the first attribute value, based on a first group modification of the first attribute value representing the first attribute value associated with each one of the plurality of keyword phrases, in response to the first group modification request.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The details of one or more implementations are set forth in the accompanying drawings and the description below. Other features will be apparent from the description and drawings, and from the claims.

### DRAWINGS

FIG. 1 is a block diagram of an example system for keyword management.

FIG. 2 is a flowchart illustrating example operations of the system of FIG. 1.

FIG. 3 is a flowchart illustrating example operations of the system of FIG. 1.

FIG. 4 is a flowchart illustrating example operations of the system of FIG. 1.

FIG. 5 depicts an example user interface for user input to the system of FIG. 1.

### DETAILED DESCRIPTION

Advertising services may provide tools for vendors to create their own advertisements, and may offer subscriptions for advertising campaigns. For example, the advertising services may wish to place advertisements with highest probabilities of user activity in web page locations where the user is most likely to read the advertisements. For example, advertisements may be placed adjacent to, or intermixed in, the top level of search results (e.g., most likely to be read), or they may be placed at the bottom of search results pages, or on pages after the first page of search results. As another example, the advertisements may be placed in one position, with timed shuffling of advertisements placed in a small, prominent location on the page. The advertising services may offer opportunities for the vendors to place bids associated with advertisement keyword phrases, in the expectation that the vendors will pay an approximate bid amount for each occurrence of a user click on a vendor's ad that is displayed to the user in association with the user's entry of one of the vendor's advertisement keyword phrases in a query. For example, ADCENTER (by MICROSOFT) and ADWORD (by GOOGLE) may provide such bidding services to vendors.

Further, the vendors may wish to avoid paying for advertisements that are not likely to lead to purchases by particular users. Thus, the vendors may wish to inhibit display of their advertisements to users who are likely to not wish to view the advertisements and subsequently make purchases. For example, a user entering a search term “vegan” may not be likely to purchase several pounds of prime rib beef from a vendor of meat products.

The vendors may accumulate very large numbers of ad keyword phrases associated with various ad campaigns, and may import increasing numbers of the ad keywords from various sources. In this context, an “ad campaign” may refer to a group of advertisements that share a common theme or advertising idea.

Example techniques discussed herein may provide management of keyword phrases based on a hierarchical storage arrangement that provides operations performed on groups of keyword phrases included in hierarchical entities. For example, a vendor may request that a bid be proffered with regard to each one of a group of keyword phrases, based on a request specifying a hierarchical entity such as a folder associated with keyword phrases for an ad campaign, as the target object of the request.

As another example, the vendor may request a report to be generated based on all the keyword phrases of an ad campaign, based on a request specifying the hierarchical entity such as the folder associated with keyword phrases for the ad campaign, as the target object of the request. For example, a keyword performance report may provide information such as the number of times a keyword has been searched by a user, with a corresponding ad shown on the search results page, a number of times an ad is clicked by a user, the payout that is to be made for a particular ad click, and other reports relating to performance of the keyword phrases associated with ad campaigns. Such reports may thus provide indications to advertisers indicating effectiveness of various keywords.

In accordance with example techniques discussed herein, such performance results may be aggregated across all keywords in an ad campaign, or may be aggregated by folder. The latter option may thus allow an advertiser to view performance by keyword folder. In accordance with example techniques discussed herein, by judicious grouping using folders, an advertiser may evaluate performance of one folder with respect to another, and may decide to increase/decrease bids on selected folders, based on the evaluation.

According to example embodiments discussed herein, adding, deleting, and setting bids with regard to large numbers of keyword phrases may be requested via operation requests directed at a hierarchical entity such as a hierarchical folder that represents a hierarchical storage entity for groups of keyword phrases associated with ad campaigns.

Example techniques discussed herein may enable advertisers to organize paid search keyword phrases into hierarchical folder structures. According to example embodiments discussed herein, the advertisers may perform group operations on the keywords included in a hierarchical folder, such as setting bids and negative keywords, or requesting reports.

Thus, according to example embodiments discussed herein, users such as vendors or advertisers may create a folder hierarchy (or category tree structure) and place keywords at various nodes in the hierarchy. According to example embodiments discussed herein, users may request performance of group operations on keywords residing in a folder (e.g. setting the same bid to all keywords in a folder, setting negative words). According to example embodiments discussed herein, the group operations may be applied to sub-folders that may be included in a folder (e.g., group operations may be propagated down through a hierarchy of sub-folders).

According to example embodiments discussed herein, users may request reports to be generated (e.g., all keywords residing in a folder may be compared together, aggregated). According to example embodiments discussed herein, bid setting may also be requested at an individual keyword phrase level, to provide flexibility.

According to an example embodiment, a root node may be established for use in importing campaigns from various services.

For example, a vendor or advertiser may generate groups of keyword phrases directly related to product(s) in hierarchical structures. For example, the vendor or advertiser may generate groups of keywords related to one or more competitors. For example, the vendor or advertiser may generate groups of keywords related to seasonal trends. For example, the vendor or advertiser may generate groups of keywords related to specific buyer intents (e.g., cheap, used, good deal, brand).

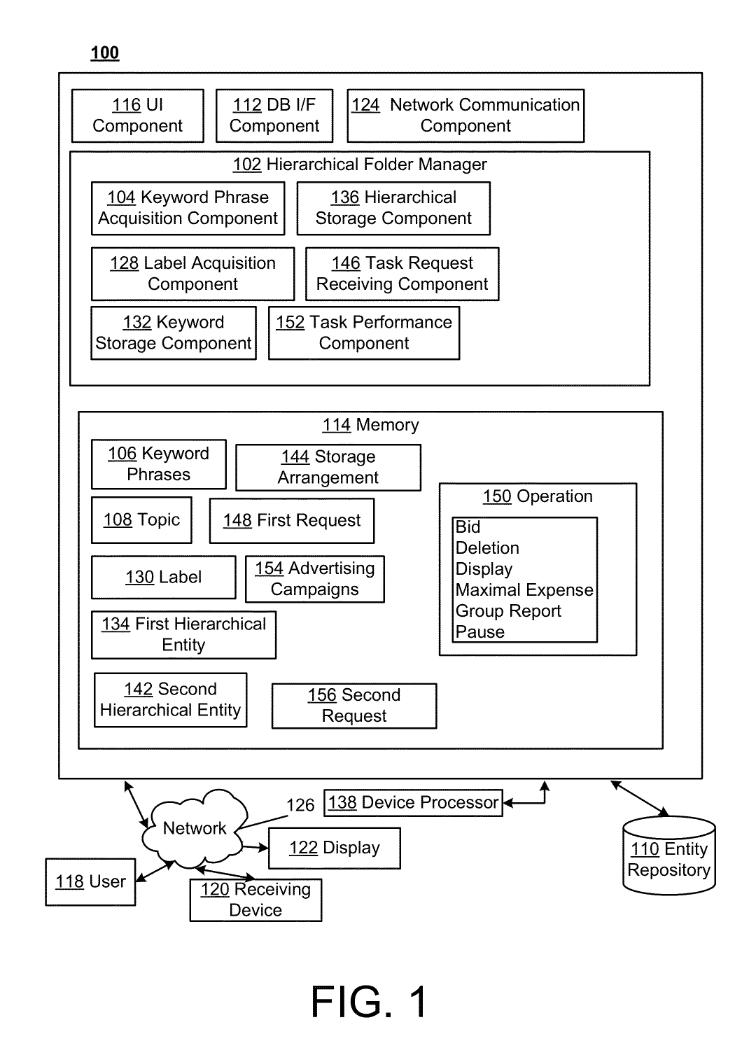

As further discussed herein, FIG. 1 is a block diagram of a system 100 for keyword management. As shown in FIG. 1, a system 100 may include a hierarchical folder manager 102 that includes a keyword phrase acquisition component 104 that may obtain a first plurality of keyword phrases 106 associated with searches that are associated with a first topic 108. For example, the first plurality of keyword phrases 106 may include keyword phrases that may be entered manually, or that may be imported from other sources or systems (or a combination thereof).

In this context, a “keyword phrase” may refer to a single word phrase or a multi-word phrase.

For example, the first plurality of keyword phrases 106 may include keywords or phrases that a vendor may deem relevant to a particular advertisement. For example, a user (e.g., a potential customer) of a search engine may enter keywords or phrases for searches, and advertisements may be displayed with the search results, based on advertisement relevance or the entered keywords or phrases. For example, the first plurality of keyword phrases 106 may include both positive and negative keywords that potential customers may enter for search engines. In this context, a “negative keyword” may include a keyword for which the vendor may not want his/her advertisement displayed as potential customers perform search on those keywords. For example, if the vendor sells meat products, then he/she may provide “vegan” as a negative keyword (e.g., as an indicator that the vendor would prefer that his/her “meat product” advertisements not be displayed to potential customers searching the term “vegan”).

According to an example embodiment, the hierarchical folder manager 102 may include executable instructions that may be stored on a computer-readable storage medium, as discussed below. According to an example embodiment, the computer-readable storage medium may include any number of storage devices, and any number of storage media types, including distributed devices.

For example, an entity repository 110 may include one or more databases, and may be accessed via a database interface component 112. One skilled in the art of data processing will appreciate that there are many techniques for storing repository information discussed herein, such as various types of database configurations (e.g., SQL SERVERS) and non-database configurations.

According to an example embodiment, the hierarchical folder manager 102 may include a memory 114 that may store the keyword phrases 106. In this context, a “memory” may include a single memory device or multiple memory devices configured to store data and/or instructions. Further, the memory 114 may span multiple distributed storage devices.

According to an example embodiment, a user interface component 116 may manage communications between a user 118 and the hierarchical folder manager 102. The user 118 may be associated with a receiving device 120 that may be associated with a display 122 and other input/output devices. For example, the display 122 may be configured to communicate with the receiving device 120, via internal device bus communications, or via at least one network connection.

According to an example embodiment, the hierarchical folder manager 102 may include a network communication component 124 that may manage network communication between the hierarchical folder manager 102 and other entities that may communicate with the hierarchical folder manager 102 via at least one network 126. For example, the at least one network 126 may include at least one of the Internet, at least one wireless network, or at least one wired network. For example, the at least one network 126 may include a cellular network, a radio network, or any type of network that may support transmission of data for the hierarchical folder manager 102. For example, the network communication component 124 may manage network communications between the hierarchical folder manager 102 and the receiving device 120. For example, the network communication component 124 may manage network communication between the user interface component 116 and the receiving device 120.

A label acquisition component 128 may obtain a first label 130 corresponding to the first topic 108. For example, the user 118 may enter the first label 130 as a text entry via the receiving device 120. For example, the first label 130 may be imported from another system with the first plurality of keyword phrases 106. For example, the first label may include a characterization associated with keywords included in a particular folder.

A keyword storage component 132 may initiate storage of the first plurality of keyword phrases 106 in association with a first hierarchical entity 134 representing the first topic 108.

A hierarchical storage component 136 may initiate, via a device processor 138, a first storage arrangement 140 of the first hierarchical entity 134 and a second hierarchical entity 142 hierarchically related to the first hierarchical entity 134, the arrangement 140 indicating a hierarchical relationship of the second hierarchical entity 142 that is higher than the first hierarchical entity 134 in a hierarchical storage arrangement 144. For example, the first storage arrangement 140 may include a hierarchical tree type of structure. For example, the first storage arrangement 140 may include hierarchical entities that may be indicated as parents (or ancestors) of one or more other hierarchical entities (e.g., nodes), and/or as children (or descendents) of one or more other hierarchical entities (e.g., nodes). For example, a hierarchical entity may represent a category, while its children may represent subcategories of the category.

In this context, a “processor” may include a single processor or multiple processors configured to process instructions associated with a processing system. A processor may thus include multiple processors processing instructions in parallel and/or in a distributed manner. Although the device processor 138 is depicted as external to the hierarchical folder manager 102 in FIG. 1, one skilled in the art of data processing will appreciate that the device processor 138 may be implemented as a single component, and/or as distributed units which may be located internally or externally to the hierarchical folder manager 102, and/or any of its elements.

A task request receiving component 146 may obtain a first request 148 to perform a first operation 150 associated with each of the first plurality of keyword phrases 106, based on the first request 148 indicating the first hierarchical entity 134 as a target of the first request 148. For example, the first request 148 may include a request for an operation to be performed on each of the first plurality of keyword phrases 106, based on the first request 148 specifying the first hierarchical entity 134 as the target of the first request 148. For example, the requested operation may include requesting a particular bid value (or a maximum bid value) to be associated with each of the first plurality of keyword phrases 106. As another example, the requested operation may include requesting a particular report to be generated, based on activities associated with each of the first plurality of keyword phrases 106. For example, a comparison of performance among all of the first plurality of keyword phrases 106 may be requested

A task performance component 152 may initiate performance of the first operation 150 associated with each of the first plurality of keyword phrases 106, in response to the first request 148 indicating the first hierarchical entity 134 as the target of the first request 148. For example, a modification of an attribute value associated with a request for the operation may be updated. For example, an attribute value indicating a request for a bid value of a particular amount may be updated in accordance with the first request 148. For example, an attribute value indicating a negative keyword phrase for association with the first plurality of keyword phrases 106 associated with a particular ad campaign may be updated in accordance with the first request 148. For example, the first request 148 may include a request for a particular type of report, based on the first plurality of keyword phrases 106.

According to an example embodiment, the first topic 108 may include a first advertisement category associated with one or more advertising campaigns 154 associated with the first plurality of keyword phrases 106. For example, the first topic 108 may include a first advertisement category such as “Vacation Rentals” associated with an advertising campaign for vacation rental real estate (e.g., tropical timeshares, Galapagos getaway condos).

According to an example embodiment, the first request 148 may include a first request 148 to perform the first operation 150, the first operation 150 including one or more of editing a bid value associated with the first plurality of keyword phrases, deleting the first plurality of keyword phrases, editing an attribute value indicating a negative keyword phrase, editing a maximal expense value associated with accumulated expenses relating to a plurality of displays of one or more related advertisements based on search queries related to any of the first plurality of keyword phrases, generating one or more reports based on activities associated with the first plurality of keyword phrases, or editing a pause attribute value associated with the first plurality of keyword phrases, indicating a request to inhibit display of the one or more related advertisements based on search queries related to any of the first plurality of keyword phrases 106.

According to an example embodiment, the first plurality of keyword phrases 106 may include one or more of a single word keyword phrase, a negative keyword phrase indicating a request to inhibit display of a related advertisement based on a search query related to the negative keyword phrase, an exact-match keyword phrase, or a multi-word keyword phrase.

According to an example embodiment, the task request receiving component 146 may obtain a second request 156 to perform a second operation 150 associated with each of the first plurality of keyword phrases 106, based on the second request 156 indicating the second hierarchical entity 142 as a target of the second request 156. For example, the second request 156 may include a request to perform an operation on keyword phrases included in association with the second hierarchical entity 142, including keyword phrases in all hierarchical sub-entities of the second hierarchical entity 142.

According to an example embodiment, the task performance component 152 may initiate performance of the second operation 150 associated with each of the first plurality of keyword phrases 106, in response to the second request 156 indicating the second hierarchical entity 142 as the target of the second request 156.

According to an example embodiment, the first hierarchical entity 134 may include a first folder.

According to an example embodiment, the second hierarchical entity may include a second folder that hierarchically includes the first folder.

According to an example embodiment, the hierarchical storage component 136 may initiate, via the device processor 138, the first storage arrangement 144 based on initiating the first storage arrangement 144 of the first folder and the second folder hierarchically related to the first folder, the arrangement indicating a hierarchical relationship of the second folder that is higher than the first folder in a hierarchical folder storage arrangement.

According to an example embodiment, the hierarchical storage component 136 may assign the first label 130 to the first folder.

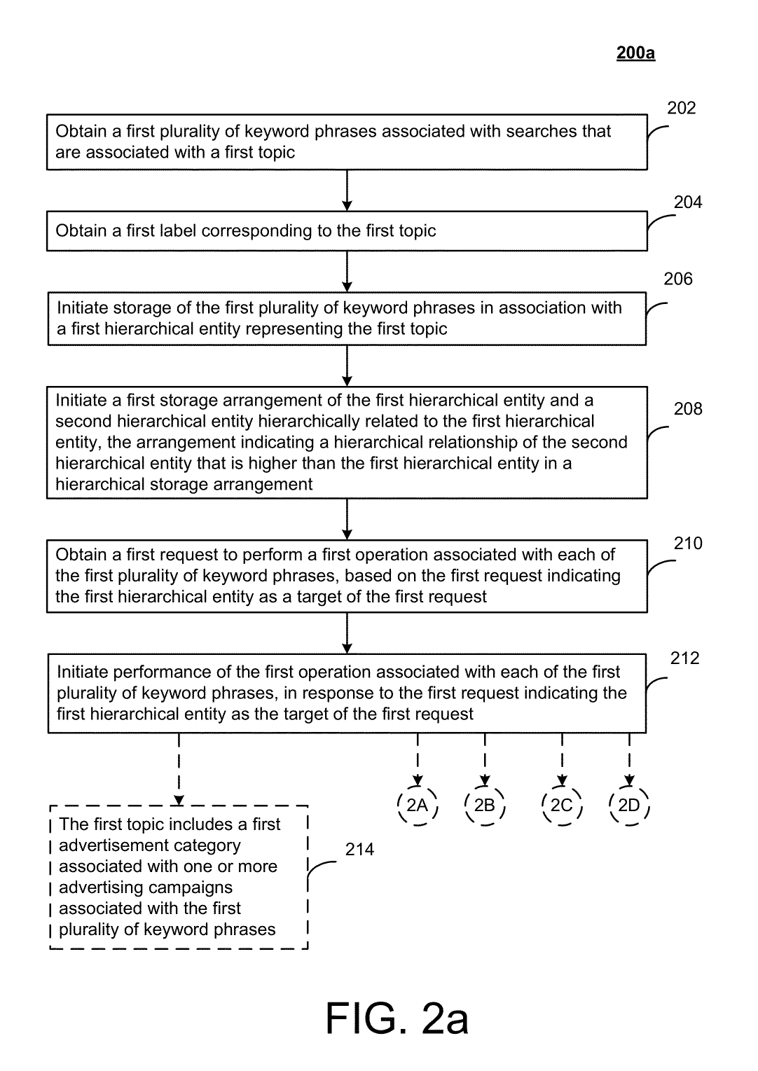

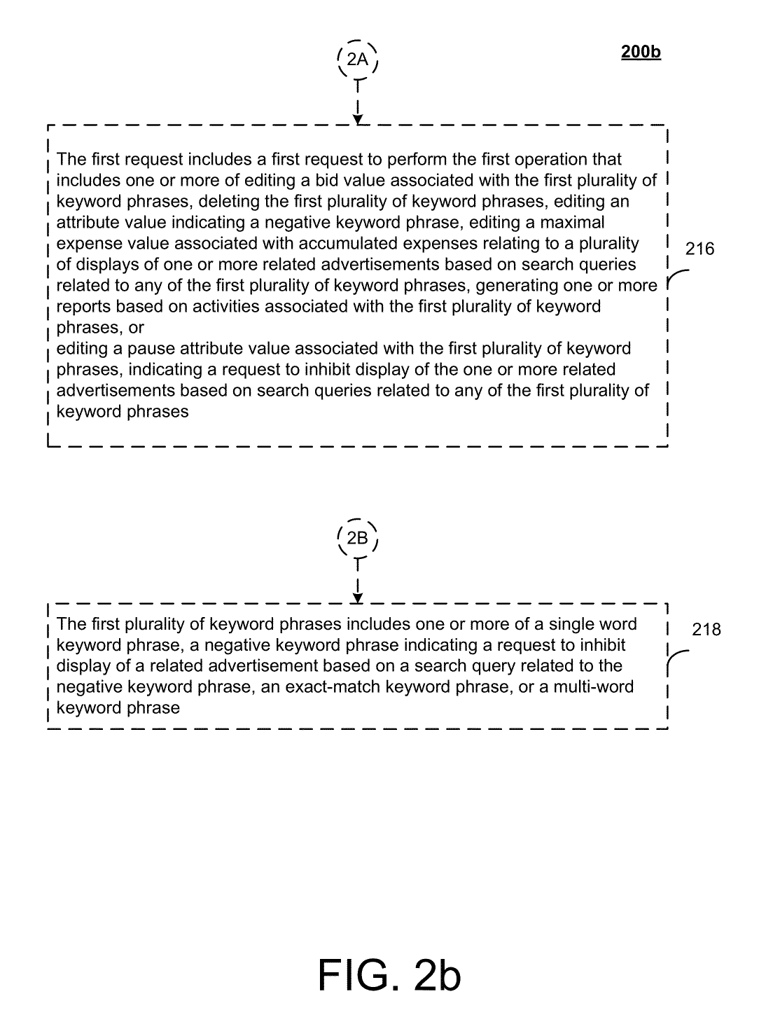

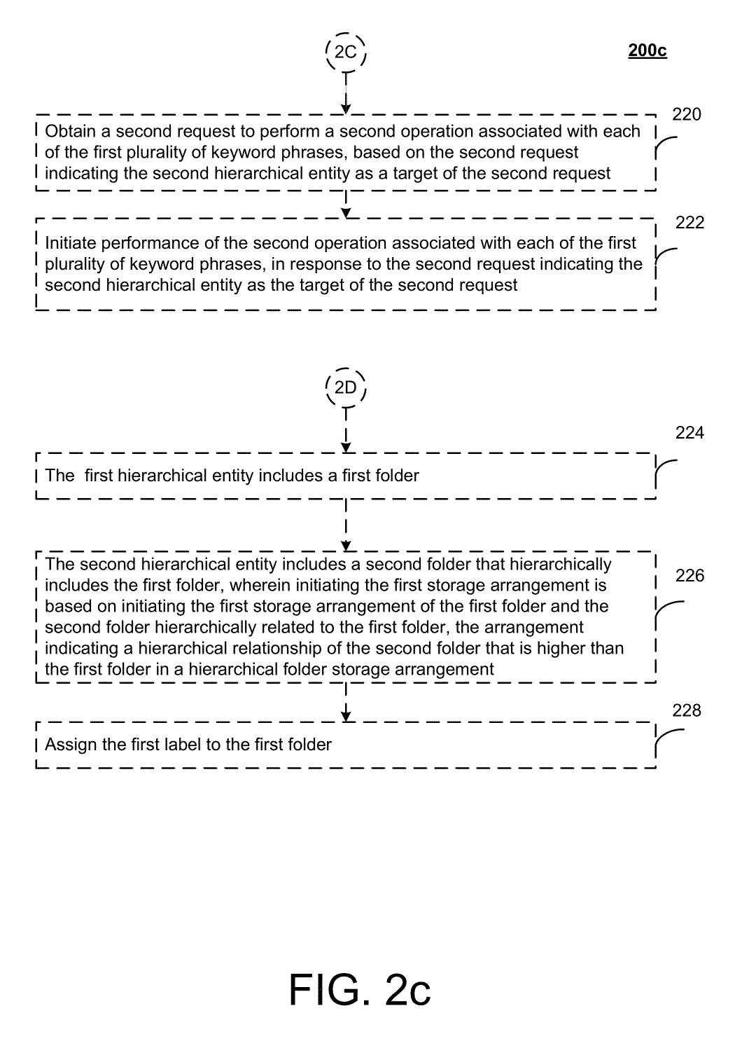

FIG. 2 is a flowchart illustrating example operations of the system of FIG. 1, according to example embodiments. In the example of FIG. 2a, a first plurality of keyword phrases associated with searches that are associated with a first topic may be obtained (202). For example, the keyword phrase acquisition component 104 may obtain a first plurality of keyword phrases 106 associated with searches that are associated with a first topic 108, as discussed above.

A first label corresponding to the first topic may be obtained (204). For example, the label acquisition component 128 may obtain the first label 130 corresponding to the first topic 108, as discussed above.

Storage of the first plurality of keyword phrases in association with a first hierarchical entity representing the first topic may be initiated (206). For example, the keyword storage component 132 may initiate storage of the first plurality of keyword phrases 106 in association with a first hierarchical entity 134 representing the first topic 108, as discussed above.

A first storage arrangement of the first hierarchical entity and a second hierarchical entity hierarchically related to the first hierarchical entity may be initiated, via a device processor, the arrangement indicating a hierarchical relationship of the second hierarchical entity that is higher than the first hierarchical entity in a hierarchical storage arrangement (208). For example, the hierarchical storage component 136 may initiate, via the device processor 138, the first storage arrangement 140 of the first hierarchical entity 134 and the second hierarchical entity 142 hierarchically related to the first hierarchical entity 134, the arrangement 140 indicating a hierarchical relationship of the second hierarchical entity 142 that is higher than the first hierarchical entity 134 in a hierarchical storage arrangement 144, as discussed above.

A first request to perform a first operation associated with each of the first plurality of keyword phrases may be obtained, based on the first request indicating the first hierarchical entity as a target of the first request (210). For example, the task request receiving component 146 may obtain the first request 148 to perform the first operation 150 associated with each of the first plurality of keyword phrases 106, based on the first request 148 indicating the first hierarchical entity 134 as a target of the first request 148, as discussed above.

A performance of the first operation associated with each of the first plurality of keyword phrases may be initiated, in response to the first request indicating the first hierarchical entity as the target of the first request (212). For example, the task performance component 152 may initiate performance of the first operation 150 associated with each of the first plurality of keyword phrases 106, in response to the first request 148 indicating the first hierarchical entity 134 as the target of the first request 148, as discussed above.

According to an example embodiment, the first topic may include a first advertisement category associated with one or more advertising campaigns associated with the first plurality of keyword phrases (214).

According to an example embodiment, the first request may include a first request to perform the first operation, the first operation including one or more of editing a bid value associated with the first plurality of keyword phrases, deleting the first plurality of keyword phrases, editing an attribute value indicating a negative keyword phrase, editing a maximal expense value associated with accumulated expenses relating to a plurality of displays of one or more related advertisements based on search queries related to any of the first plurality of keyword phrases, generating one or more reports based on activities associated with the first plurality of keyword phrases, or editing a pause attribute value associated with the first plurality of keyword phrases, indicating a request to inhibit display of the one or more related advertisements based on search queries related to any of the first plurality of keyword phrases (216).

According to an example embodiment, the first plurality of keyword phrases may include one or more of a single word keyword phrase, a negative keyword phrase indicating a request to inhibit display of a related advertisement based on a search query related to the negative keyword phrase, an exact-match keyword phrase, or a multi-word keyword phrase (218).

According to an example embodiment, a second request to perform a second operation associated with each of the first plurality of keyword phrases may be obtained, based on the second request indicating the second hierarchical entity as a target of the second request (220). For example, the task request receiving component 146 may obtain the second request 156 to perform the second operation 150 associated with each of the first plurality of keyword phrases 106, based on the second request 156 indicating the second hierarchical entity 142 as a target of the second request 156, as discussed above.

According to an example embodiment, a performance of the second operation associated with each of the first plurality of keyword phrases may be initiated, in response to the second request indicating the second hierarchical entity as the target of the second request (222). For example, the task performance component 152 may initiate performance of the second operation 150 associated with each of the first plurality of keyword phrases 106, in response to the second request 156 indicating the second hierarchical entity 142 as the target of the second request 156, as discussed above.

According to an example embodiment, the first hierarchical entity may include a first folder (224).

According to an example embodiment, the second hierarchical entity may include a second folder that hierarchically includes the first folder, wherein the first storage arrangement may be initiated based on initiating the first storage arrangement of the first folder and the second folder hierarchically related to the first folder, the arrangement indicating a hierarchical relationship of the second folder that is higher than the first folder in a hierarchical folder storage arrangement (226). For example, the hierarchical storage component 136 may initiate, via the device processor 138, the first storage arrangement 144 based on initiating the first storage arrangement 144 of the first folder and the second folder hierarchically related to the first folder, the arrangement indicating a hierarchical relationship of the second folder that is higher than the first folder in a hierarchical folder storage arrangement, as discussed above.

According to an example embodiment, the hierarchical storage component may assign the first label to the first folder (228).

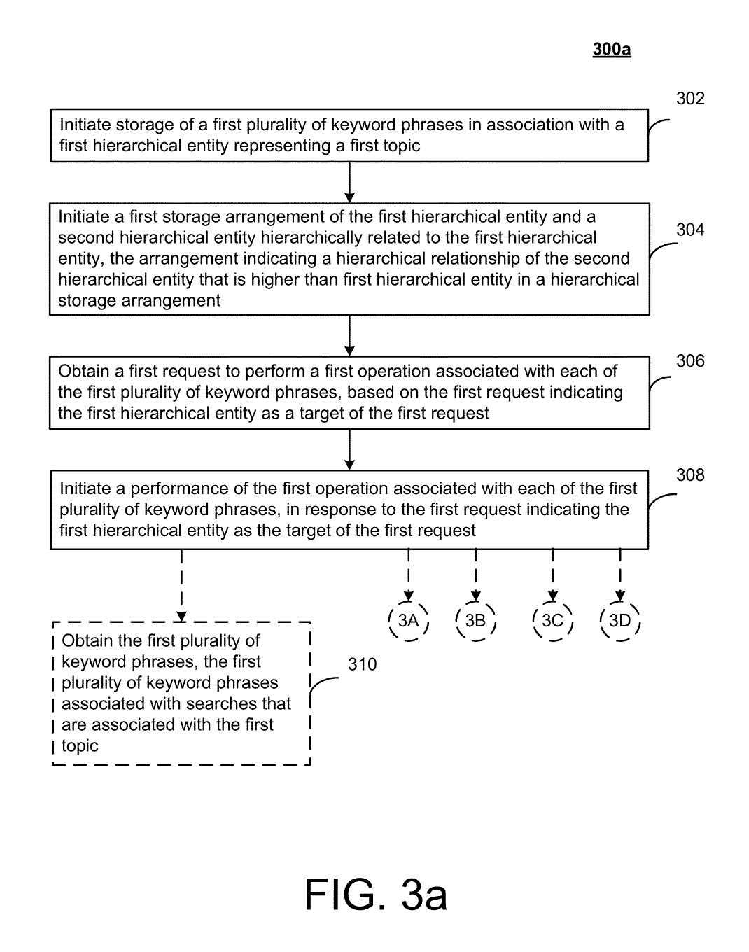

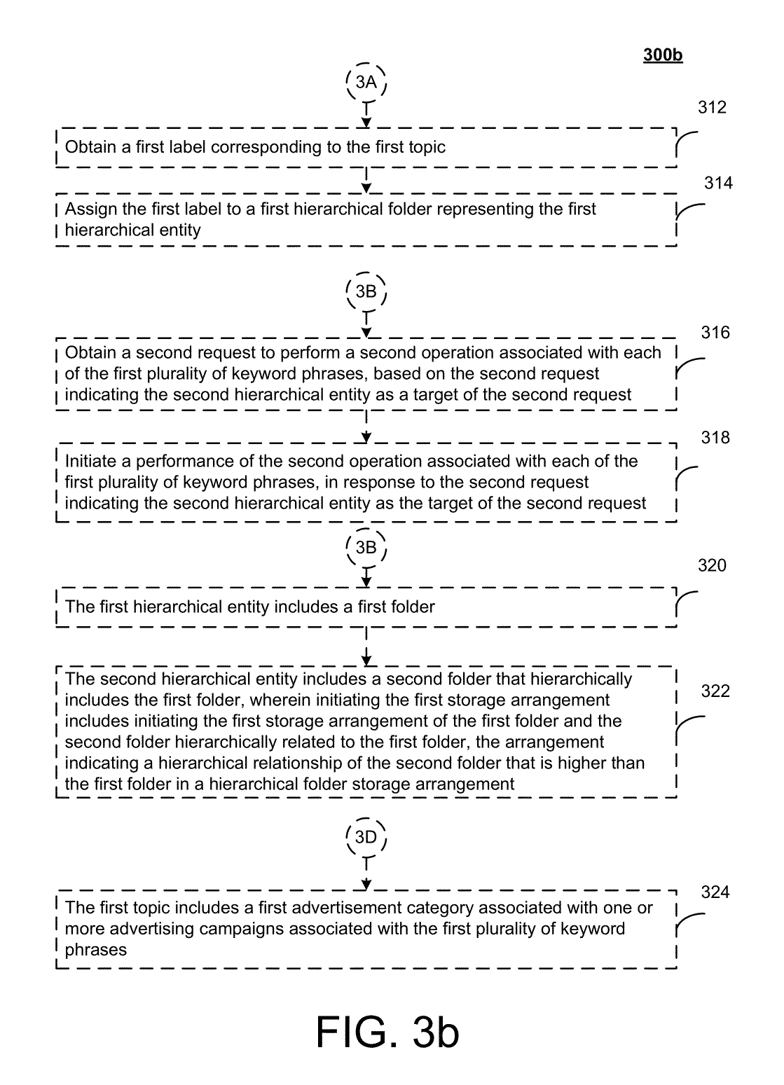

FIG. 3 is a flowchart illustrating example operations of the system of FIG. 1, according to example embodiments. In the example of FIG. 3a, storage of a first plurality of keyword phrases in association with a first hierarchical entity representing a first topic may be initiated (302). For example, the keyword storage component 132 may initiate storage of the first plurality of keyword phrases 106 in association with a first hierarchical entity 134 representing the first topic 108, as discussed above.

A first storage arrangement of the first hierarchical entity and a second hierarchical entity hierarchically related to the first hierarchical entity may be initiated, via a device processor, the arrangement indicating a hierarchical relationship of the second hierarchical entity that is higher than first hierarchical entity in a hierarchical storage arrangement (304). For example, the hierarchical storage component 136 may initiate, via the device processor 138, the first storage arrangement 140 of the first hierarchical entity 134 and the second hierarchical entity 142 hierarchically related to the first hierarchical entity 134, the arrangement 140 indicating a hierarchical relationship of the second hierarchical entity 142 that is higher than the first hierarchical entity 134 in the hierarchical storage arrangement 144, as discussed above.

A first request to perform a first operation associated with each of the first plurality of keyword phrases may be obtained, based on the first request indicating the first hierarchical entity as a target of the first request (306). For example, the task request receiving component 146 may obtain a first request 148 to perform a first operation 150 associated with each of the first plurality of keyword phrases 106, based on the first request 148 indicating the first hierarchical entity 134 as a target of the first request 148, as discussed above.

A performance of the first operation associated with each of the first plurality of keyword phrases may be initiated, in response to the first request indicating the first hierarchical entity as the target of the first request (308). For example, the task performance component 152 may initiate a performance of the first operation 150 associated with each of the first plurality of keyword phrases 106, in response to the first request 148 indicating the first hierarchical entity 134 as the target of the first request 148, as discussed above.

According to an example embodiment, the first plurality of keyword phrases may be obtained, the first plurality of keyword phrases associated with searches that are associated with the first topic (310). For example, the keyword phrase acquisition component 104 may obtain the first plurality of keyword phrases 106 associated with searches that are associated with the first topic 108, as discussed above.

According to an example embodiment, a first label corresponding to the first topic may be obtained (312). For example, the label acquisition component 128 may obtain the first label 130 corresponding to the first topic 108, as discussed above.

According to an example embodiment, the first label may be assigned to a first hierarchical folder representing the first hierarchical entity (314). For example, the hierarchical storage component 136 may assign the first label 130 to the first hierarchical folder, as discussed above.

According to an example embodiment, a second request to perform a second operation associated with each of the first plurality of keyword phrases may be obtained, based on the second request indicating the second hierarchical entity as a target of the second request (316). For example, the task request receiving component 146 may obtain the second request 156 to perform a second operation 150 associated with each of the first plurality of keyword phrases 106, based on the second request 156 indicating the second hierarchical entity 142 as a target of the second request 156, as discussed above.

According to an example embodiment, a performance of the second operation associated with each of the first plurality of keyword phrases may be initiated, in response to the second request indicating the second hierarchical entity as the target of the second request (318). For example, the task performance component 152 may initiate a performance of the second operation 150 associated with each of the first plurality of keyword phrases 106, in response to the second request 156 indicating the second hierarchical entity 142 as the target of the second request 156, as discussed above.

According to an example embodiment, the first hierarchical entity may include a first folder (320).

According to an example embodiment, the second hierarchical entity may include a second folder that hierarchically includes the first folder, wherein initiating the first storage arrangement may include initiating the first storage arrangement of the first folder and the second folder hierarchically related to the first folder, the arrangement indicating a hierarchical relationship of the second folder that is higher than the first folder in a hierarchical folder storage arrangement (322).

According to an example embodiment, the first topic may include a first advertisement category associated with one or more advertising campaigns associated with the first plurality of keyword phrases (324).

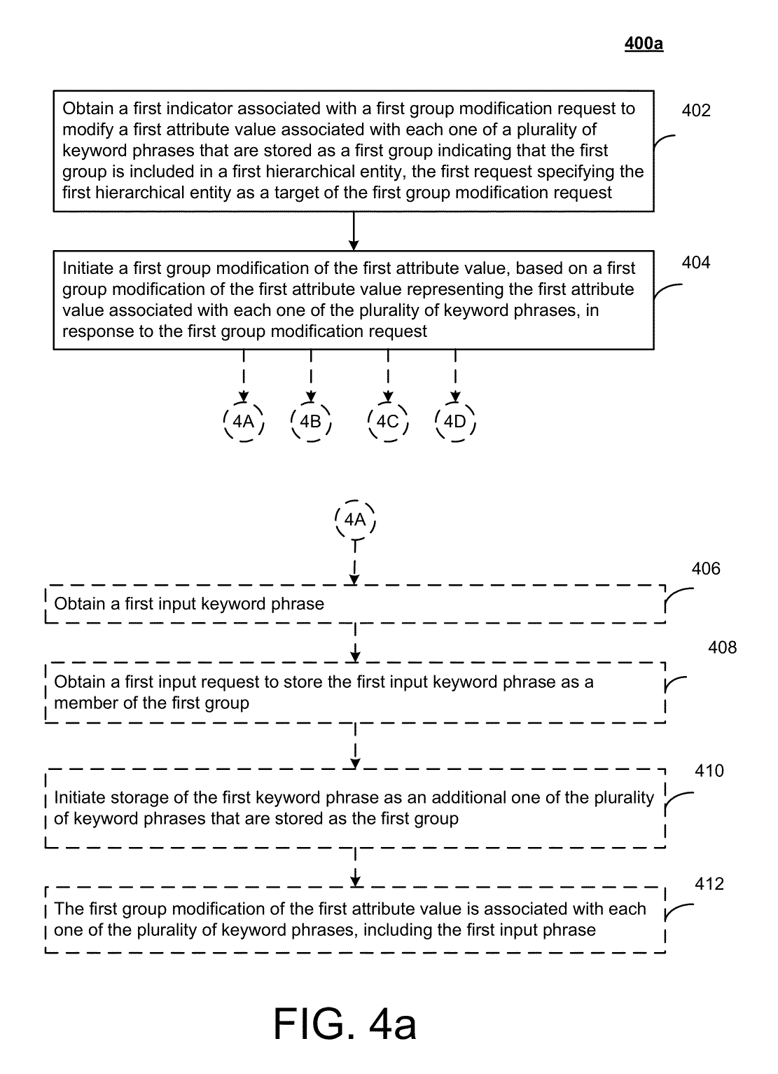

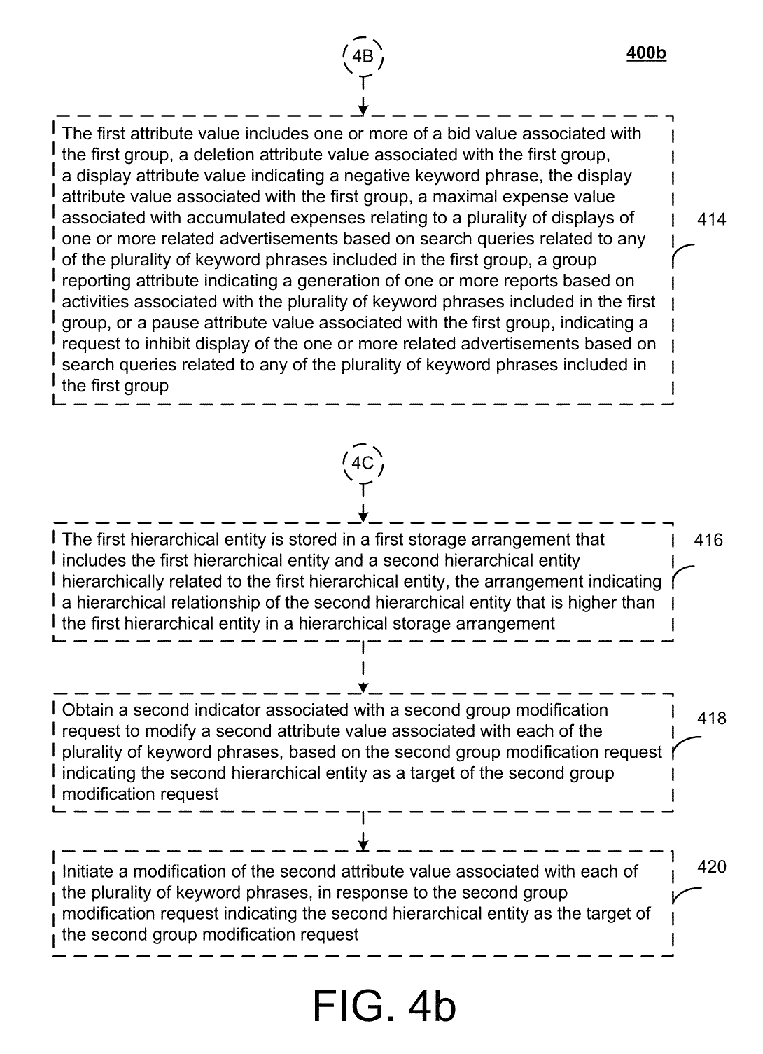

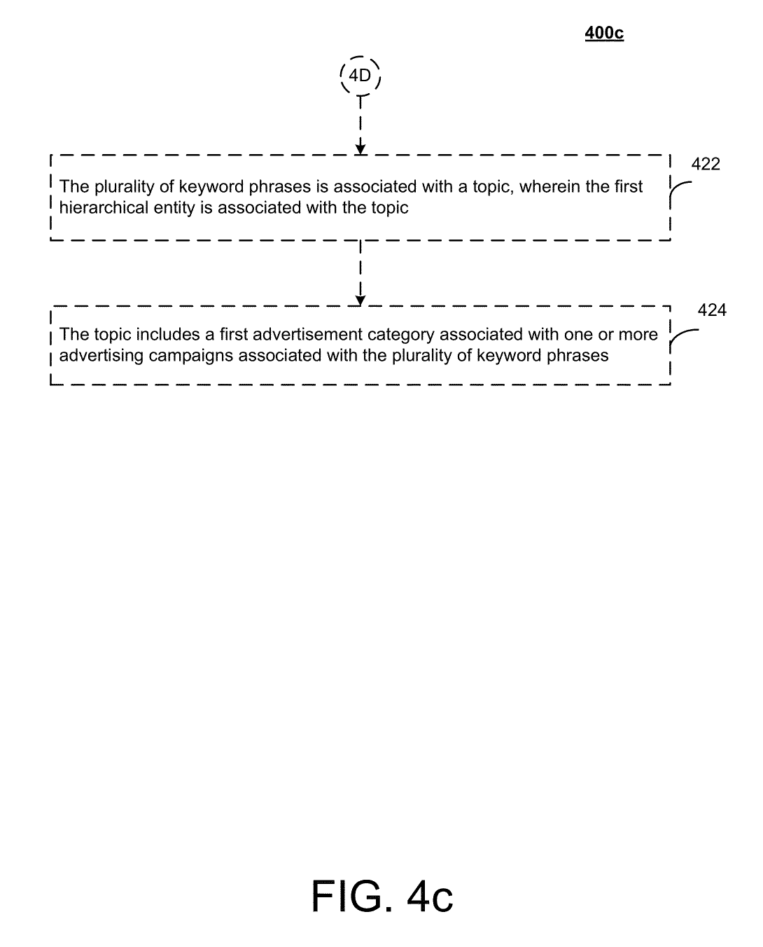

FIG. 4 is a flowchart illustrating example operations of the system of FIG. 1, according to example embodiments. In the example of FIG. 4a, a first indicator associated with a first group modification request to modify a first attribute value associated with each one of a plurality of keyword phrases that are stored as a first group indicating that the first group is included in a first hierarchical entity may be obtained, the first request specifying the first hierarchical entity as a target of the first group modification request (402). For example, the task request receiving component 146 may obtain the first indicator associated with the first group modification request.

A first group modification of the first attribute value may be initiated, based on a first group modification of the first attribute value representing the first attribute value associated with each one of the plurality of keyword phrases, in response to the first group modification request (404). For example, the task performance component 152 may initiate a modification of the first attribute value.

According to an example embodiment, a first input keyword phrase may be obtained (406). For example, the keyword phrase acquisition component 104 may obtain the first input keyword phrase 106.

According to an example embodiment, a first input request to store the first input keyword phrase as a member of the first group may be obtained (408).

According to an example embodiment, storage of the first keyword phrase as an additional one of the plurality of keyword phrases that are stored as the first group may be initiated, via the device processor (410).

According to an example embodiment, the first group modification of the first attribute value may be associated with each one of the plurality of keyword phrases, including the first input phrase (412).

According to an example embodiment, the first attribute value may include one or more of a bid value associated with the first group, a deletion attribute value associated with the first group, a display attribute value indicating a negative keyword phrase, the display attribute value associated with the first group, a maximal expense value associated with accumulated expenses relating to a plurality of displays of one or more related advertisements based on search queries related to any of the plurality of keyword phrases included in the first group, a group reporting attribute indicating a generation of one or more reports based on activities associated with the plurality of keyword phrases included in the first group, or a pause attribute value associated with the first group, indicating a request to inhibit display of the one or more related advertisements based on search queries related to any of the plurality of keyword phrases included in the first group (414).

According to an example embodiment, the first hierarchical entity may be stored in a first storage arrangement that includes the first hierarchical entity and a second hierarchical entity hierarchically related to the first hierarchical entity, the arrangement indicating a hierarchical relationship of the second hierarchical entity that is higher than the first hierarchical entity in a hierarchical storage arrangement (416).

According to an example embodiment, a second indicator associated with a second group modification request to modify a second attribute value associated with each of the plurality of keyword phrases may be obtained, based on the second group modification request indicating the second hierarchical entity as a target of the second group modification request (418).

According to an example embodiment, a modification of the second attribute value associated with each of the plurality of keyword phrases may be initiated, in response to the second group modification request indicating the second hierarchical entity as the target of the second group modification request (420).

According to an example embodiment, the plurality of keyword phrases may be associated with a topic, wherein the first hierarchical entity may be associated with the topic (422).

According to an example embodiment, the topic may include a first advertisement category associated with one or more advertising campaigns associated with the plurality of keyword phrases (424).

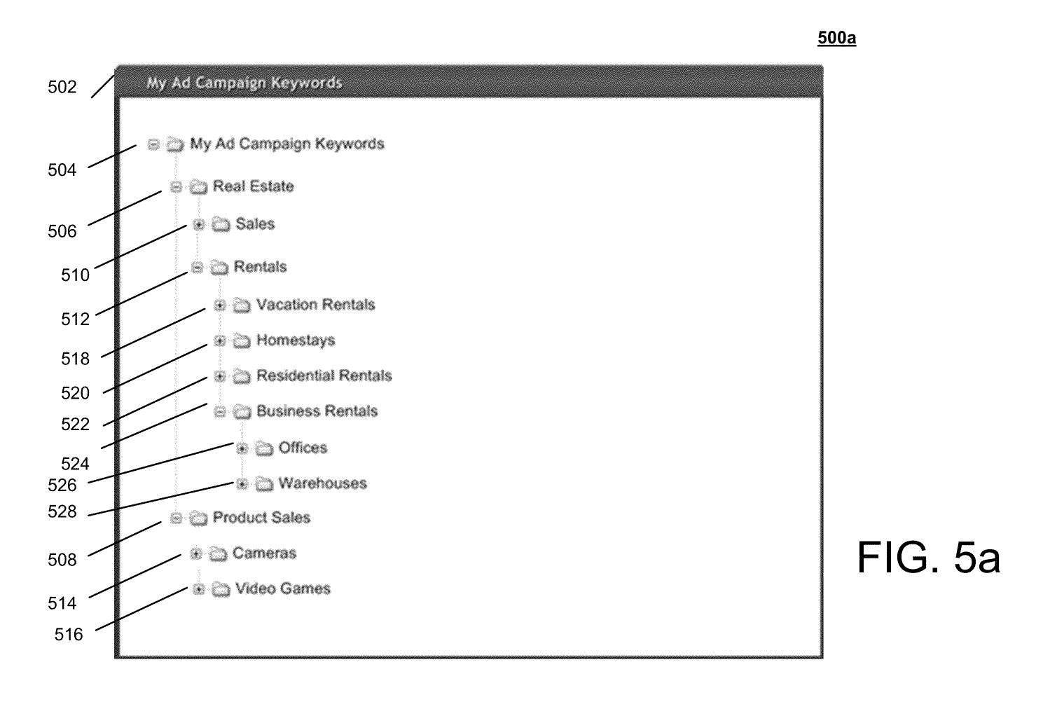

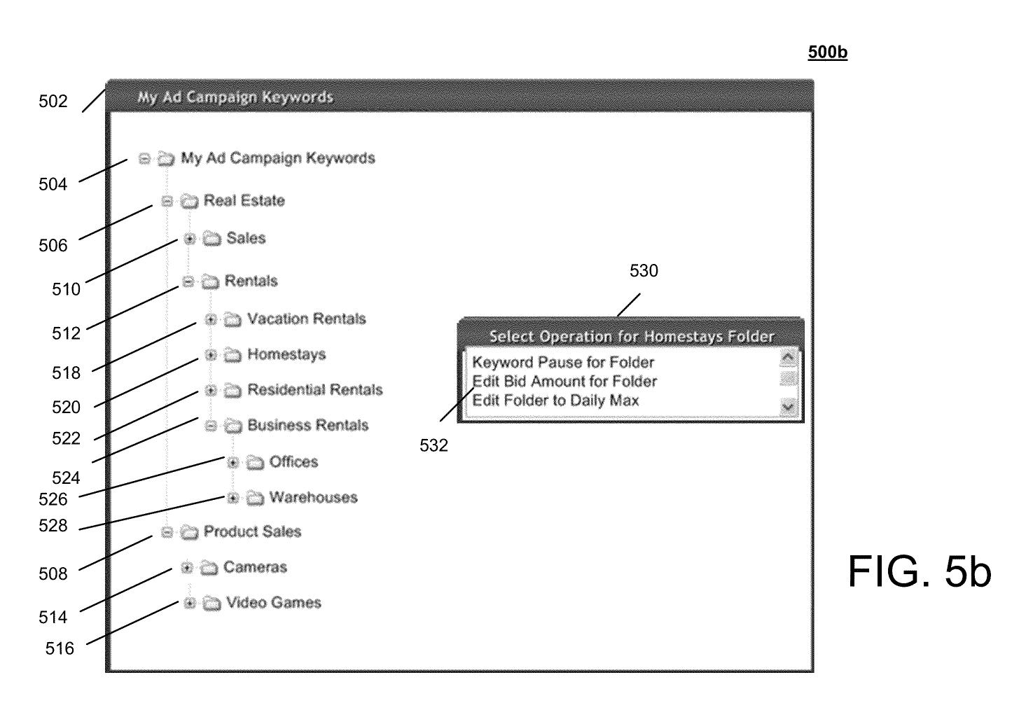

FIG. 5 depicts an example user interface for user input to the system of FIG. 1. As shown in FIG. 5a, a viewing pane 502 depicts a display of hierarchical entities, depicted as a hierarchy of folders associated with “My Ad Campaign Keywords.” For example, the folders may be associated with groups of keywords or keyword phrases associated with ad campaigns associated with web advertising for one or more vendors. As shown in FIG. 5a, a root folder 504 indicates a highest displayed hierarchical entity indicated as “My Ad Campaign Keywords.”

Under the root folder 504, child nodes are indicated as “Real Estate” (506) and “Product Sales” (508). For example, the vendor may manage one or more businesses involved in real estate and product sales.

Children folders of “Real Estate” (506) are indicated as “Sales” (510) and “Rentals” (512). Thus, for example, the vendor may engage in (and advertise for) both sales and rentals of real estate.

Children folders of “Product Sales” (508) are indicated as “Cameras” (514) and “Video Games” (516). Thus, for example, the vendor may engage in (and advertise for) sales of both cameras and video games. For example, subfolders of “Cameras” (514) and “Video Games” (516) may include subfolders associated with manufacturers of cameras and video games, respectively.

Children folders of “Rentals” (512) are indicated as “Vacation Rentals” (518), “Homestays” (520), “Residential Rentals” (522), and “Business Rentals” (524). Children folders of “Business Rentals” (524) are indicated as “Offices” (526) and “Warehouses” (528). For example, the vendor may store keywords or keyword phrases associated with ad campaigns related to topics indicated by labels of the folders. The keywords or keyword phrases may indicate various search terms that potential customers may enter as search queries, for which the vendor may wish one or more of his/her ads included in an ad campaign to be displayed to the potential customer (or have the ad displays inhibited via negative keyword phrases).

For example, ad keywords/keyword phrases associated with “Vacation Rentals” (518) may include terms such as “Italian villa”, “Acapulco seaside”, or “Tropical Timeshare.” For example, a negative ad keyword associated with “Vacation Rentals” (518) may include “cheap” or “inexpensive.”

The vendor may perform many types of operations on the ad keywords or keyword phrases. For example, the user may wish to place bids on the ad keywords, or may request a maximal daily expenditure per ad campaign (or ad keyword), or may request that one or more ad keywords be treated as negative keywords. As another example, the vendor may request reports based on ad keywords or keyword phrases. For example, the vendor may wish to view a comparison of performance among ad keywords or keyword phrases associated with one or more ad campaigns. For example, the vendor may wish to view a report indicating a cumulative cost per ad keyword or keyword phrase.

As shown in FIG. 5b, a viewing pane 530 depicts a display of selectable operations options 532 for selection by a user (e.g., the user 118). For example, the user 118 may request the display of the options 532 via activation of an icon in a task tray or via a right click in the viewing pane 502. As shown in FIG. 5b, the selectable operations options 532 may include at least a keyword pause for a folder, an edit of a bid amount for a folder, and/or an edit of a folder daily maximum. For example, the user 118 may select one of the folders, and select an operation of pausing ad keywords or keyword phrases included in the selected folder, including ad keywords or keyword phrases included in subfolders in the hierarchy of folders down to leaf nodes in the hierarchy of folders. Thus, by selecting the “Homestays” (520) folder, and further selecting the operation of “Keyword Pause for Folder,” the user 118 may initiate an operation to pause all the ad keywords or keyword phrases included in the “Homestays” (520) folder, and/or in any hierarchically lower subfolders stored under the “Homestays” (520) folder. For example, as a result of the pause request, no ads from ad campaigns related to the paused ad keywords or keyword phrases will be generated based on search queries that include any of the ad keywords or keyword phrases that are paused.

As another example, the user 118 may select an operation indicating generation of a report, based on one of the hierarchical folders. For example, the user 118 may thus initiate an operation of submitting a request to generate a report based on all the ad keywords or keyword phrases included in the “Homestays” (520) folder, and/or in any hierarchically lower subfolders stored under the “Homestays” (520) folder. For example, the user 118 may request a report indicating the average cost to date of submitted bids on all such ad keywords or keyword phrases.

Example techniques discussed herein may thus provide user management of large numbers of ad keywords or keyword phrases associated with ad campaigns.

Customer privacy and confidentiality have been ongoing considerations in online environments for many years. Thus, example techniques for managing advertisement keywords may use data provided by users having an intent to post information publicly, and may thus avoid accessing data that may be personal to particular users.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine usable or machine readable storage device (e.g., a magnetic or digital medium such as a Universal Serial Bus (USB) storage device, a tape, hard disk drive, compact disk, digital video disk (DVD), etc.) or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand alone program or as a module, component, subroutine, or other unit suitable for use in a computing environment. A computer program that might implement the techniques discussed above may be deployed to be executed on one computer or on multiple computers at one site or distributed across multiple sites and interconnected by a communication network.

Method steps may be performed by one or more programmable processors executing a computer program to perform functions by operating on input data and generating output. The one or more programmable processors may execute instructions in parallel, and/or may be arranged in a distributed configuration for distributed processing. Method steps also may be performed by, and an apparatus may be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back end component, e.g., as a data server, or that includes a middleware component, e.g., an application server, or that includes a front end component, e.g., a client computer having a graphical user interface or a Web browser through which a user can interact with an implementation, or any combination of such back end, middleware, or front end components. Components may be interconnected by any form or medium of digital data communication, e.g., a communication network. Examples of communication networks include a local area network (LAN) and a wide area network (WAN), e.g., the Internet.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A system comprising:
a keyword phrase acquisition component that obtains a first plurality of keyword phrases associated with searches that are associated with a first topic;
a label acquisition component that obtains a first label corresponding to the first topic;
a keyword storage component that initiates storage of the first plurality of keyword phrases in association with a first hierarchical entity representing the first topic;
a hierarchical storage component that initiates, via a device processor, a first storage arrangement of the first hierarchical entity and a second hierarchical entity hierarchically related to the first hierarchical entity, the arrangement indicating a hierarchical relationship of the second hierarchical entity that is higher than the first hierarchical entity in a hierarchical storage arrangement;
a task request receiving component that obtains a first request to perform a first operation associated with each of the first plurality of keyword phrases, based on the first request indicating the first hierarchical entity as a target of the first request; and
a task performance component that initiates performance of the first operation associated with each of the first plurality of keyword phrases, in response to the first request indicating the first hierarchical entity as the target of the first request.

2. The system of claim 1, wherein:
the first topic includes a first advertisement category associated with one or more advertising campaigns associated with the first plurality of keyword phrases.

3. The system of claim 1, wherein:
the first request includes a first request to perform the first operation that includes one or more of:
editing a bid value associated with the first plurality of keyword phrases,
deleting the first plurality of keyword phrases,
editing an attribute value indicating a negative keyword phrase,
editing a maximal expense value associated with accumulated expenses relating to a plurality of displays of one or more related advertisements based on search queries related to any of the first plurality of keyword phrases,
generating one or more reports based on activities associated with the first plurality of keyword phrases, or
editing a pause attribute value associated with the first plurality of keyword phrases, indicating a request to inhibit display of the one or more related advertisements based on search queries related to any of the first plurality of keyword phrases.

4. The system of claim 1, wherein:
the first plurality of keyword phrases includes one or more of:
a single word keyword phrase,
a negative keyword phrase indicating a request to inhibit display of a related advertisement based on a search query related to the negative keyword phrase,
an exact-match keyword phrase, or
a multi-word keyword phrase.

5. The system of claim 1, wherein:
the task request receiving component obtains a second request to perform a second operation associated with each of the first plurality of keyword phrases, based on the second request indicating the second hierarchical entity as a target of the second request; and
the task performance component initiates performance of the second operation associated with each of the first plurality of keyword phrases, in response to the second request indicating the second hierarchical entity as the target of the second request.

6. The system of claim 1, wherein:
the first hierarchical entity includes a first folder, and
the second hierarchical entity includes a second folder that hierarchically includes the first folder, wherein
the hierarchical storage component initiates, via the device processor, the first storage arrangement based on initiating the first storage arrangement of the first folder and the second folder hierarchically related to the first folder, the arrangement indicating a hierarchical relationship of the second folder that is higher than the first folder in a hierarchical folder storage arrangement.

7. The system of claim 6, wherein:
the hierarchical storage component assigns the first label to the first folder.

8. A method comprising:
initiating storage of a first plurality of keyword phrases in association with a first hierarchical entity representing a first topic;
initiating, via a device processor, a first storage arrangement of the first hierarchical entity and a second hierarchical entity hierarchically related to the first hierarchical entity, the arrangement indicating a hierarchical relationship of the second hierarchical entity that is higher than first hierarchical entity in a hierarchical storage arrangement;
obtaining a first request to perform a first operation associated with each of the first plurality of keyword phrases, based on the first request indicating the first hierarchical entity as a target of the first request; and
initiating a performance of the first operation associated with each of the first plurality of keyword phrases, in response to the first request indicating the first hierarchical entity as the target of the first request.

9. The method of claim 8, further comprising:
obtaining the first plurality of keyword phrases, the first plurality of keyword phrases associated with searches that are associated with the first topic.

10. The method of claim 8, further comprising:
obtaining a first label corresponding to the first topic; and
assigning the first label to a first hierarchical folder representing the first hierarchical entity.

11. The method of claim 8, further comprising:
obtaining a second request to perform a second operation associated with each of the first plurality of keyword phrases, based on the second request indicating the second hierarchical entity as a target of the second request; and
initiating a performance of the second operation associated with each of the first plurality of keyword phrases, in response to the second request indicating the second hierarchical entity as the target of the second request.

12. The method of claim 8, wherein:
the first hierarchical entity includes a first folder, and
the second hierarchical entity includes a second folder that hierarchically includes the first folder, wherein
initiating the first storage arrangement includes initiating the first storage arrangement of the first folder and the second folder hierarchically related to the first folder, the arrangement indicating a hierarchical relationship of the second folder that is higher than the first folder in a hierarchical folder storage arrangement.

13. The method of claim 8, wherein:
the first topic includes a first advertisement category associated with one or more advertising campaigns associated with the first plurality of keyword phrases.

14. A computer program product tangibly embodied on a computer-readable storage medium and including executable code that causes at least one data processing apparatus to:
obtain a first indicator associated with a first group modification request to modify a first attribute value associated with each one of a plurality of keyword phrases that are stored as a first group indicating that the first group is included in a first hierarchical entity, the first request specifying the first hierarchical entity as a target of the first group modification request; and
initiate, via a device processor, a first group modification of the first attribute value, based on a first group modification of the first attribute value representing the first attribute value associated with each one of the plurality of keyword phrases, in response to the first group modification request.

15. The computer program product of claim 14, wherein the executable code is configured to cause the at least one data processing apparatus to:
obtain a first input keyword phrase;
obtain a first input request to store the first input keyword phrase as a member of the first group; and
initiate, via the device processor, storage of the first keyword phrase as an additional one of the plurality of keyword phrases that are stored as the first group, wherein:
the first group modification of the first attribute value is associated with each one of the plurality of keyword phrases, including the first input phrase.

16. The computer program product of claim 14, wherein:
the first attribute value includes one or more of:
a bid value associated with the first group,
a deletion attribute value associated with the first group,
a display attribute value indicating a negative keyword phrase, the display attribute value associated with the first group,
a maximal expense value associated with accumulated expenses relating to a plurality of displays of one or more related advertisements based on search queries related to any of the plurality of keyword phrases included in the first group,
a group reporting attribute indicating a generation of one or more reports based on activities associated with the plurality of keyword phrases included in the first group, or
a pause attribute value associated with the first group, indicating a request to inhibit display of the one or more related advertisements based on search queries related to any of the plurality of keyword phrases included in the first group.

17. The computer program product of claim 14, wherein:
the first hierarchical entity is stored in a first storage arrangement that includes the first hierarchical entity and a second hierarchical entity hierarchically related to the first hierarchical entity, the arrangement indicating a hierarchical relationship of the second hierarchical entity that is higher than the first hierarchical entity in a hierarchical storage arrangement.

18. The computer program product of claim 17, wherein the executable code is configured to cause the at least one data processing apparatus to:
obtain a second indicator associated with a second group modification request to modify a second attribute value associated with each of the plurality of keyword phrases, based on the second group modification request indicating the second hierarchical entity as a target of the second group modification request; and
initiate a modification of the second attribute value associated with each of the plurality of keyword phrases, in response to the second group modification request indicating the second hierarchical entity as the target of the second group modification request.

19. The computer program product of claim 14, wherein:
the plurality of keyword phrases is associated with a topic, wherein
the first hierarchical entity is associated with the topic.

20. The computer program product of claim 19, wherein:
the topic includes a first advertisement category associated with one or more advertising campaigns associated with the plurality of keyword phrases.
